(19) United States
(12) Patent Application Publication
(10) Pub. No.: US 2016/0031754 A1
(43) Pub. Date: Feb. 4, 2016

(54) PROCESS FOR PRODUCING PHASE SEPARATION GLASS FILM, PROCESS FOR PRODUCING POROUS GLASS FILM, GLASS MEMBER, AND IMAGING DEVICE

(71) Applicant: CANON KABUSHIKI KAISHA, Tokyo (JP)

(72) Inventors: Naoyuki Koketsu, Tokyo (JP); Zuyi Zhang, Yokohama-shi (JP); Yoshinori Kotani, Yokohama-shi (JP)

(21) Appl. No.: 14/802,111

(22) Filed: Jul. 17, 2015

(30) Foreign Application Priority Data
Jul. 29, 2014 (JP) 2014-153916
May 12, 2015 (JP) 2015-097399

(51) Int. Cl. C03C 23/00; C03C 11/00; H04N 5/225; C03C 17/04

(52) U.S. Cl. CPC C03C 23/008; C03C 17/04; C03C 11/005; H04N 5/2254; C03C 2217/70

(57) ABSTRACT

A process for producing a phase separation glass film including a film formation step of forming a film including glass powder on both faces of a substrate, and a baking step of baking the film to form a phase separation glass film on both faces of the substrate simultaneously. The baking step is performed in a state in which the substrate is disposed such that an in-plane direction of the substrate is perpendicular to a gravitational direction by supporting the substrate at a portion where the film is not formed. In the baking step, a member having a thermal conductivity higher than that of the substrate is disposed below the substrate so as not to be in contact with the film.

### BACKGROUND OF THE INVENTION

1. Field of the Invention

The present invention relates to a process for producing a phase separation glass film, a process for producing a porous glass film, a glass member, and an imaging device.

2. Description of the Related Art

Recently, porous glass has drawn attention, and for example, industrial application of an adsorptive agent, a microcarrier, a separation film, an optical material, or the like using excellent properties of the porous glass has been expected. However, porous glass has various problems such as uniformity of surface strength, void content, and void diameter, and the like. In particular, when porous glass is used as an optical material, it is necessary to more specifically control the void content of the porous glass in order to suppress scattering and reflection of light.

As a process of comparatively easily producing porous glass, there is a process utilizing a phase separation phenomenon of the glass itself. In particular, the porous glass which is produced by using a spinodal phase separation phenomenon of the glass has a continuous porous structure which is uniformly controlled to have the shape of a mesh, and thus has a high void content compared to other porous materials. For this reason, the porous glass having a spinodal porous structure is a highly hopeful member from a viewpoint of industrial application.

As a base material of the porous glass using the phase separation phenomenon, borosilicate glass is generally used in which silica, boric oxide, an alkali metal oxide, and the like are used as a raw material. The molded borosilicate glass is subjected to a treatment (a heat treatment) in which the glass is maintained at a constant temperature, and thus a phase separation phenomenon occurs. Hereinafter, the treatment (the heat treatment) described above is referred to as a phase separation heat treatment. The borosilicate glass which is subjected to the phase separation heat treatment is etched by an acidic solution, and thus a non-silica-rich phase which is a component soluble in an acid is eluted. For this reason, a skeleton constituting the porous glass is mainly silica (a silica-rich phase). The skeleton diameter, the pore diameter, and the void content of the thus-obtained porous glass are highly affected by the composition of the glass before the phase separation heat treatment as well as the temperature or the time of the phase separation heat treatment. Further, the skeleton diameter, the pore diameter, or the void content of the porous glass is also highly affected by optical properties.

On the other hand, the phase separation phenomenon is a phenomenon of forming a nanosized three-dimensional microstructure, and thus it is extremely difficult to perform selective etching to an inner portion of the glass, and thus it is difficult to obtain uniform pores. As means for obtaining the uniform pores by sufficiently performing selective etching, thinning of glass is mentioned. However, when phase separation is performed with respect to thinned base glass by a heat treatment, the face accuracy of the glass becomes deteriorated due to the movement of a constituent element at the time of the phase separation, and thus it is difficult to obtain an excellent porous glass thin layer. Furthermore, when the glass is thinned, the inner portion of the glass is subjected to excellent selective etching, but the strength of a structured object thereof decreases.

Therefore, as a method of utilizing special surface properties of a spinodal phase separation porous material, there is a method of forming thin film porous glass on a substrate. As means for forming the thin film porous glass on the substrate, for example, a printing method is mentioned. Specifically, powder is formed by pulverizing borosilicate glass which is a base material, and then a paste is formed by mixing the powder with a resin. The paste is printed on the substrate, and is subjected to a heat treatment, and thus a glass film is formed on the substrate. After that, by performing a phase separation heat treatment, a silica-rich phase and a non-silica-rich phase are separated from each other, and the non-silica-rich phase is removed by etching, and thus a porous film is able to be formed on the substrate (Japanese Patent Application Laid-Open No. 2013-033188).

However, when the porous film is formed on one face (front surface) of the substrate in the process described above, and then the porous film is formed on the other face (back surface) by the same process, the temperature of the heat treatment which is performed during the process is high, and thus a phenomenon occurs in which skeletons of the porous glass film which is formed in advance are bonded to each other, and thus voids disappear. Accordingly, when the porous glass film is formed on both faces of the substrate, it is required that the porous glass film is simultaneously formed on both faces, but such a production process has not been established.

In addition, in order to simultaneously form the porous glass film on both faces of the substrate, there is such a process that a film including base glass is applied onto both faces of the substrate followed by subjecting the film to a heat treatment. However, when the heat treatment is performed in a state where the substrate is erected, the glass included in the film flows at the time that the glass is melted, and thus a uniform film is not formed. In addition, in the state where the substrate is erected, a portion of the substrate which is in contact with a base is small, and thus thermal unevenness also occurs in the film.

### SUMMARY OF THE INVENTION

The present invention is made in order to solve the problems described above, and an object of the present invention is to provide a process for producing a phase separation glass film for simultaneously forming a porous glass film on both faces of a substrate in which the porous glass film and the substrate are formed of the same material.

According to an aspect of the present invention, there is provided a process for producing a phase separation glass film, comprising a film formation step of forming a film including a glass powder on both faces of a substrate; and a baking step of baking the film to form a phase separation glass film on the both faces of the substrate simultaneously, in which the baking step is performed in a state in which the substrate is disposed such that an in-plane direction of the substrate is perpendicular to a gravitational direction by supporting the substrate at a portion where the film is not formed, and in the baking step, a member having a thermal conductivity higher than that of the substrate is disposed below the substrate so as not to be in contact with the film.

Further features of the present invention will become apparent from the following description of an exemplary embodiment with reference to the attached drawings.

### BRIEF DESCRIPTION OF THE DRAWINGS

FIGS. 1A, 1B, 1C, 1D and 1E are schematic sectional views illustrating an example of an embodiment of a process for producing a porous glass film according to the present invention.

FIG. 2 is a diagram illustrating a frequency for each image density of the porous glass film having a spinodal porous structure.

FIGS. 3A and 3B are diagrams illustrating a specific example of definition of a pore diameter of a pore of the porous glass film and a skeleton diameter of a skeleton between pores.

FIG. 4 is a schematic sectional view illustrating an example of an imaging device on which an optical member including the porous glass film which is obtained by a production process of the present invention is mounted.

FIG. 5A is a sectional view of a sample prepared in Example 1, FIG. 5B is an SEM image of the porous glass film on a front surface side of a substrate, and FIG. 5C is an SEM image of the porous glass film on a back surface side of the substrate.

FIG. 6 is a diagram illustrating transmittance of an optical member prepared in Example 1.

### DESCRIPTION OF THE EMBODIMENTS

Preferred Embodiments of the Present Invention will now be described in detail in accordance with the accompanying drawings.

A process for producing a phase separation glass film of the present invention includes the following steps (1) and (2).

(1) A film formation step of forming a film including glass powder on both faces of a substrate.
(2) A baking step of baking the film and of simultaneously forming a phase separation glass film on both faces of the substrate.

In addition, a process for producing a porous glass film of the present invention also includes the steps (1) and (2) described above, and further includes the following step (3).

(3) An etching step of performing an etching treatment with respect to the phase separation glass film to form a porous glass film on both faces of the substrate simultaneously.

In the present invention, the baking step is performed in a state where the substrate is disposed such that an in-plane direction of the substrate is perpendicular to a gravitational direction by supporting the substrate at a portion where the film is not formed. In addition, in the baking step, a member having a thermal conductivity higher than that of the substrate is disposed below the substrate so as not to be in contact with the film.

In the production process of the present invention, the film including the glass powder is formed on both faces of the substrate, and the substrate is caused to be disposed at a predetermined disposing position by a support to be perpendicular to the gravitational direction. By disposing the substrate to be perpendicular to the gravitational direction, softened glass is prevented from being biased by an influence of a gravitational force at the time of heating the glass powder to form a glass film, and thus it is possible to prepare a uniform film. In addition, the film disposed on both faces of the substrate is disposed so as not to be in contact with the support or with the member disposed below the substrate having high thermal conductivity. The glass powder is fused by being heated, and thus it is not preferable that the glass film is formed in a state of being in contact with a member other than the substrate. However, in the baking step, only the member supporting the substrate is used, and thus thermal unevenness easily occurs in the film, and it is difficult to prepare a homogeneous film. Therefore, the film formed on the substrate is heated in a state in which the member having a thermal conductivity higher than that of the substrate is disposed below the substrate so as not to be in contact with the film. Accordingly, a homogeneous glass film is formed on both faces. Subsequently, a phase separation glass film is formed on both faces of the substrate by performing a phase separation heat treatment, and then a porous glass film is formed on both faces of the substrate by performing the etching treatment. Accordingly, it is possible to form a porous glass film having a porous structure (a spinodal structure) derived from a spinodal phase separation structure, which comprises a continuous hole, on both faces. Thus, in the present invention, it is possible to prepare the porous glass film which is disposed on each of both faces of the substrate under the same conditions, and thus the warp of the substrate due to a difference in thermal expansion of the film decreases, and thus it is possible to obtain an optical member having high transmittance.

Hereinafter, embodiments of the present invention will be described in detail with reference to the drawings. However, the present invention is not limited to the embodiments described later. In addition, in the drawings, a known or a publicly-known technology in the related art is able to be applied to a portion which is not particularly illustrated in the drawings or a portion which is not particularly described in the following description.

Phase Separation Glass Film and Process for Producing Porous Glass Film

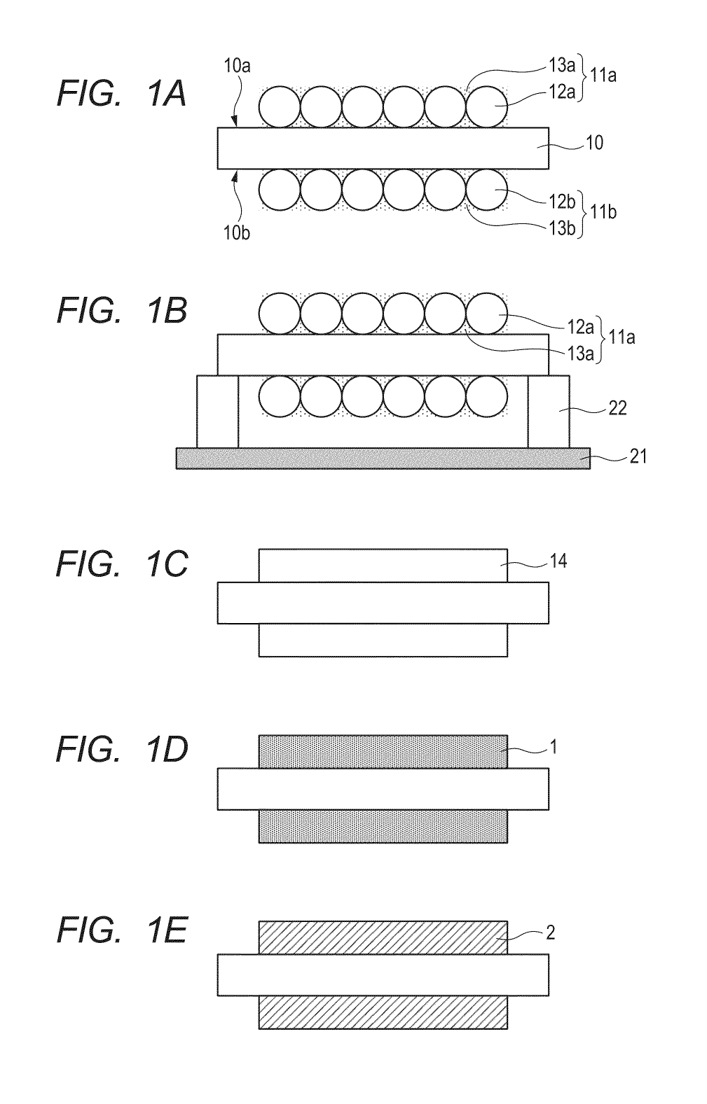

FIGS. 1A to 1E are schematic sectional views illustrating an example of an embodiment of a process for producing a porous glass film according to the present invention. Here, the porous glass film of the present invention (reference sign 2 in FIG. 1E) is produced through a phase separation glass film 1 in FIG. 1D, and thus FIGS. 1A to 1E are diagrams illustrating an example of an embodiment of a process for producing a phase separation glass film according to the present invention.

Hereinafter, each production process will be described.

(1) Film Formation Step (FIG. 1A)

First, for producing the porous glass film of the present invention, a film 11 including glass powder 12 is formed on a substrate 10 (FIG. 1A).

(1-1) Substrate

As the substrate 10 on which the film including the glass powder is disposed, a substrate formed of an arbitrary material is able to be used according to a purpose. For example, quartz glass, quartz, sapphire, and the like are mentioned.

(1-2) Glass Powder

The glass powder 12 is able to be prepared by using a general process for producing a powder shaped glass. The material of the glass powder is not particularly limited, and as the material of the glass powder, for example, silicon oxide based glass I (base glass composition: silicon oxide-boric oxide-alkali metal oxide), silicon oxide based glass II (base glass composition: silicon oxide-boric oxide-alkali metal oxide-(alkaline earth metal oxide, zinc oxide, aluminum oxide, and zirconium oxide)), titanium oxide based glass (base glass composition: silicon oxide-boric oxide-calcium oxide-magnesium oxide-aluminum oxide-titanium oxide), and the like are mentioned. Among them, the borosilicate-based glass of silicon oxide-boric oxide-alkali metal oxide is preferable. Furthermore, when quartz glass is used as the substrate 10, borate glass may be used.

When the glass powder 12 formed of borosilicate-based glass is used, the ratio of silicon oxide included in the glass constituting the glass powder 12 is preferably 55.0 weight % to 95.0 weight %, and is particularly preferably 60.0 weight % to 85.0 weight %. By controlling the ratio of the silicon oxide included in the glass such that the ratio is in the range described above, a phase separation glass film and a porous glass film which have a high skeleton strength tend to be easily obtained, and thus it is effective when the strength of the glass film itself is required. In addition, it is preferable that the molar ratio of boron and an alkali component included in the glass constituting the glass powder 12 satisfies Expression (α) described below.

0.25<[Na/B]<0.4 (α)

When Expression (α) is not satisfied, the film breaks due to expansion or contraction of the film itself at the time of performing the etching step.

In the present invention, the base glass is used in a powder state, and a specific process for processing the base glass into a powder state will be described later.

On the other hand, when borate glass is used as the glass constituting the glass powder 12, in the subsequent baking step, sodium oxide, a boric acid, and silicon oxide constituting the substrate 10 react with each other, and thus the composition of a base glass film 14 to be formed becomes the composition of a phase separation glass.

(1-3) Application and Formation of Film Including Base Glass Powder

As a process for forming the film 11 including the glass powder 12, for example, a printing method, a spin coating method, a dip coating method, and the like are mentioned. Hereinafter, as a specific process for forming the film 11, a process using a general screen printing method will be described.

The screen printing method is a process for printing a past substance including glass powder on a substrate or the like by using a screen printer, and thus the preparation of the paste substance is essential.

As a precondition for preparing the above-described paste substrate, the glass of “(1-2)” described above is subjected to powdering to obtain glass powder. The powdering process is not particularly limited, and as the process, a publicly-known powdering process is able to be used. As an example of the powdering process, a pulverizing process in a liquid phase, as represented by a bead mill, or a pulverizing process in a vapor phase, as represented by a jet mill or the like, is mentioned.

The particle diameter of the pulverized glass is suitably controlled according to the size of a plate used in the screen printing or the design thickness. However, when the particle diameter increases, the speed of sedimentation increases at the time of performing pasting, and thus it is difficult to maintain uniformity. In addition, there is such a situation that it is difficult to uniformly form a printed film, and thus it is preferable that the particle diameter of the glass is less than or equal to 20 μm. In addition, in the present invention, it is particularly preferable that the average particle diameter of the pulverized glass powder 12 is less than or equal to 10 μm. This can prevent glass powder 12b from being dropped out from the substrate 10 in a process from decomposition of a binder 13 to fusion of the substrate 10 and the glass powder 12b or to mutual fusion of the glass powder 12b due to softening of the glass powder 12b, in a heat treatment performed in the subsequent step (baking step). Specifically, a difference between the glass transition temperature and the decomposition temperature of the binder is lower than or equal to 300° C., and thus the particle diameter of the glass powder is set according to this temperature difference. As a general condition in the present invention, the removal temperature of the binder 13 is 300° C. to 400° C., and the glass transition temperature is 450° C. to 550° C. In addition, the fusing temperature of the glass is 600° C. to 700° C. At this time, when the particle diameter of the glass powder (12a and 12b) is less than or equal to 10 μm, an attachment force of the glass powder (12a and 12b) with respect to the substrate 10 is sufficiently exhibited, and the dropout of the glass powder (12a and 12b) is able to be suppressed, and thus the glass powder (12a and 12b) having a particle diameter of less than or equal to 10 μm is particularly preferable.

When a film including the glass powder (coating film) is formed, it is necessary that a paste containing the glass powder described above is prepared. In this paste, a thermoplastic resin, a plasticizing agent, a solvent, and the like are contained together with the glass powder described above.

When the paste is prepared, the ratio of a base glass powder contained in the paste is desirably 30.0 weight % to 90.0 weight %, and is preferably 35.0 weight % to 70.0 weight %, on the basis of the total weight of the paste.

When the paste is prepared, a thermoplastic resin contained in the paste is a component which increases the strength of a film which is formed by drying the paste, and applies flexibility to the film. As the thermoplastic resin, polybutyl methacrylate, polyvinyl butyral, polymethyl methacrylate, polyethyl methacrylate, ethyl cellulose, and the like are able to be used. One of the thermoplastic resins may be independently used, or a plurality thereof may be used in combination. Furthermore, the thermoplastic resin contained in the paste functions as the binder (13a and 13b) constituting the film 11 illustrated in FIG. 1A.

It is preferable that the content of the thermoplastic resin contained in the paste is 0.1 weight % to 30.0 weight %, on the basis of the total weight of the paste. When the content of the thermoplastic resin is less than 0.1 weight %, the strength of the film which is formed by drying the paste tends to be weak. In contrast, when the content of the thermoplastic resin is greater than 30.0 weight %, a residual component of the resin easily remains in the glass film at the time of forming the glass film, which is not preferable.

In the present invention, a plasticizing agent may be suitably contained in the paste. By adding the plasticizing agent, it is possible to control the drying rate of the paste. In addition, it is possible to apply flexibility to the film which is formed by drying the paste. Examples of the plasticizing agent contained in the paste include butyl benzyl phthalate, dioctyl phthalate, diisooctyl phthalate, dicapryl phthalate, dibutyl phthalate, and the like. One of the plasticizing agents may be independently used, or a plurality thereof may be used in combination.

When the plasticizing agent is contained in the paste, it is preferable that the content of the plasticizing agent is less than or equal to 10.0 weight % on the basis of the total weight of the paste.

When the paste is prepared, a solvent is suitably used along with the thermoplastic resin. As the solvent contained in the paste, terpineol, diethylene glycol monobutyl ether acetate, 2,2,4-trimethyl-1,3-pentanediol monoisobutyrate, and the like are mentioned. One of the solvents may be independently used, or a plurality thereof may be used in combination.

It is preferable that the content of the solvent contained in the paste is 10.0 weight % to 90.0 weight % on the basis of the total weight of the paste. When the content of the solvent is less than 10.0 weight %, a uniform film tends to be rarely obtained. In addition, when the content of the solvent is greater than 90.0 weight %, a uniform film also tends to be rarely obtained.

When the paste is prepared, the materials described above are able to be kneaded at a predetermined ratio.

In the present step, first, the paste is applied onto one face of the substrate 10 (for example, front surface 10a) by using screen printing. After that, solvent components of the paste are dried and removed. Next, the paste is applied onto the other face of the substrate 10 (for example, back surface 10b) by using screen printing, and solvent components of the paste are dried and removed. Accordingly, the film (11a and 11b) containing the base glass powder (12a and 12b) illustrated in FIG. 1A is able to be formed on both faces (10a and 10b) of the substrate 10. In addition, in order to set the thickness of the film (11a and 11b) to a desired thickness, the base-glass-containing paste may be repeatedly applied and dried an arbitrary number of times.

(2) Baking Step (FIGS. 1B to 1D)

Next, the film (11a and 11b) including the glass powder (12a and 12b) which is applied onto and formed on both faces (10a and 10b) of the substrate 10 is baked, and thus the phase separation glass film 1 is formed. Specifically, the present step includes the following steps (2-1) and (2-2).

(2-1) Step of forming base glass film 14 by heat treatment (first heat treatment step, FIGS. 1B and 1C).
(2-2) Step of forming phase separation glass film 1 by heat treatment (second heat treatment step, FIG. 1D).

(2-1) First Heat Treatment Step (FIGS. 1B and 1C)

When a first heat treatment step is performed, a heat treatment is performed as illustrated in FIG. 1B. Specifically, the substrate 10 is disposed on a support member 22 such that the substrate 10 is perpendicular to the gravitational direction, and is supported at a portion where the film (11a and 11b) is not formed. Then, the heat treatment is performed in a state where a member having a thermal conductivity higher than that of quartz glass (a thermally conductive member 21) is disposed on at least below the substrate 10 by the support member 22. Accordingly, the base glass film 14 on both faces of the substrate 10 is formed in a uniform state for the both faces. In addition, as illustrated in FIG. 1B, by disposing the substrate 10 to be perpendicular to the gravitational direction, it is possible to prevent the bias of the melted glass which is able to occur in the present step.

In the present step, the angle between a plane direction of the substrate 10 and the gravitational direction is desirably 80° to 100°, and is preferably a right angle (90°). In particular, when the heat treatment temperature is high, the viscosity of the glass tends to be lower, and the bias of the film easily occurs, and thus it is preferable that the angle described above is a right angle. In addition, it is desirable that the substrate and the thermally conductive member are disposed parallel to each other. By disposing the substrate and the thermally conductive member parallel to each other, it is possible to make the distance between the substrate and the thermal conductive member constant, and as a result thereof, it is possible to suppress thermal unevenness.

In the present step, the distance between the substrate 10 and the thermally conductive member 21 is desirably 1 mm to 100 mm, and is preferably 2 mm to 50 mm. By setting the distance between the substrate 10 and the thermally conductive member 21 to be less than or equal to 50 mm, heat generated from the thermally conductive member 21 is uniformly transmitted to a coating face on the side of the back surface 10b of the substrate 10. As a result, the distribution of temperature on the side of the back surface 10b of the substrate 10 becomes narrower, and thus it is possible to obtain a uniform glass film on the side of the back surface 10b of the substrate 10. In addition, by setting the distance between the substrate 10 and the thermally conductive member 21 to be greater than or equal to 1 mm, it is possible to prevent the melt of the glass and the thermally conductive member 21 from being in contact with each other.

As the constituent material of the thermally conductive member 21, a material having high thermal conductivity, and specifically, a material having a thermal conductivity higher than that of the substrate 10 is able to be used. When quartz glass is used for the substrate 10, examples of the constituent material of the thermally conductive member 21 include specifically, Si, SiC, Al₂O₃, and the like. Here, the thermal conductivity of the quartz glass is less than or equal to 10 W/m·k, but the thermal conductivity of Al₂O₃ is 15 W/m·k to 40 W/m·k, the thermal conductivity of Si is 150 W/m·k to 170 W/m·k, and the thermal conductivity of SiC is 100 W/m·k to 350 W/m·k. For this reason, all of Si, SiC, and Al₂O₃ are members having thermal conductivity higher than that of the quartz glass. Among these members, when a Si substrate or a SiC substrate having properties of absorbing heat rays emitted from a heat source (not illustrated) is used, the heat is transmitted from the thermally conductive member 21 to the substrate 10, and thus it is possible to make heat transmission excellent.

The present step (first heat treatment step), for example, is performed in a range of 700° C. to 1000° C. and in a range of 5 minutes to 1 hour.

(2-2) Second Heat Treatment Step (Phase Separation Step, FIG. 1D)

The base glass film 14 which is flattened by the first heat treatment step is formed, and then a second heat treatment step is performed (FIG. 1D). Furthermore, the second heat treatment step is also referred to as a phase separation heat treatment.

According to the present step, the phase separation of the base glass film 14 is accelerated, and thus a layer in which a silica-rich phase and a non-silica-rich phase are separated from each other (phase separation glass film 1) is formed.

In the present invention, the second heat treatment step is performed at a temperature which is lower than that of the first heat treatment step, and is preferably performed at a temperature of 500° C. to 700° C. In addition, the second heat treatment step is generally performed in a range of 1 hour to 100 hours. However, the temperature condition or the time condition of the present step is able to be suitably set according to the size of the non-silica-rich phase which is desired to be obtained (corresponding to the pore diameter of the pore of the porous glass film 2) or the like. Here, in order to suppress scattering of light in the porous glass film 2 which is obtained through steps described later, it is necessary that the pore diameter of the pore of the porous glass film 2 is less than or equal to 50 nm, and in order to realize this pore diameter, it is necessary that the condition of the phase separation heat treatment is suitably adjusted.

In addition, in temperature setting at the time of performing the present step, it is not necessary to make the temperature constant at a predetermined temperature, and the setting temperature may be continuously and/or stepwise changed within the preferred range described above.

In addition, as described above, the present step is performed at a temperature lower than that of the first heat treatment step. For this reason, the present step may be performed during a cooling procedure within the system which is performed after the first heat treatment step or, for example, after the substrate 10 is cooled to the normal temperature followed by heating again, after the first heat treatment step.

(3) Etching Step (FIG. 1E)

According to the second heat treatment step, the phase separation glass film 1 of the present invention is obtained, and in order to obtain the porous glass film 2 from the phase separation glass film 1, it is necessary to perform an etching treatment described below. Specifically, the etching treatment is a step of removing the non-silica-rich phase of the phase separation glass film 1 by a treatment using an aqueous solution. According to the present step, the porous glass film 2 which is formed of only the silica-rich phase is able to be obtained (FIG. 1E).

The etching treatment (an etching treatment of removing the non-silica-rich phase) performed in the present step is generally a treatment of eluting the non-silica-rich phase which is a phase soluble in water by bringing the glass in contact with an aqueous solution. As means for bringing the aqueous solution in contact with the glass, means for dipping the glass in the aqueous solution is used in general, and the means is not limited as long as the glass and the aqueous solution are brought into contact with each other by applying the aqueous solution onto the glass or the like. As the aqueous solution necessary for the etching treatment, a general solution such as water, an acidic solution, and an alkaline solution which is able to elute the non-silica-rich phase is able to be used. In addition, a plurality of steps of bringing the aqueous solution in contact with the glass may be selected according to a purpose.

When the phase separation glass film 1 is etched, in general, a treatment using an acidic aqueous solution is preferably used from a viewpoint of a small load to a portion of the non-soluble phase (the silica-rich phase) and the degree of selective etching. By bringing the acidic aqueous solution in contact with the phase separation glass film 1, the non-silica-rich phase which is a component soluble in an acid is eluted and removed, but the erosion of the silica-rich phase is comparatively small, and thus it is possible to perform the present step with highly selective etching properties.

As the acidic aqueous solution used in the present step, for example, an inorganic acid such as hydrochloric acid and nitric acid is preferable. In addition, it is preferable that the acidic aqueous solution used in the present step is generally used in a state of being suitably diluted with water (solvent), i.e. aqueous solution. In general, it is preferable that the concentration of the acidic solution is suitably set in a range of 0.1 mol/L to 2.0 mol/L. In addition, in the present step, it is preferable that the temperature of the acidic aqueous solution is able to be in a range of room temperature to 100° C., and it is preferable that the required time (treatment time) of the present step is able to be approximately 1 hour to 500 hours.

Furthermore, a silica layer (silica-rich phase) of approximately a few hundred nanometers inhibiting the etching may be generated on the surface of the phase separation glass film 1 which is obtained by the second heat treatment step, depending on the glass composition of the phase separation glass film 1. In this case, the silica layer on the surface of the phase separation glass film 1 may be removed by using polishing, an alkali treatment, or the like.

(4) Water Cleaning Treatment

After the etching step ends, finally, it is preferable that the substrate 10 is cleaned with water. By performing the cleaning with water, it is possible to prevent a residual component from being attached to the skeleton constituting the porous glass film 2, and thus the porous glass film 2 having higher porosity tends to be obtained. The temperature of the cleaning water used at the time of performing the cleaning with water may be generally in a range of room temperature to 100° C. In addition, the time for which the cleaning with water is performed is able to be suitably determined according to the composition and the size of the porous glass film 2 which is a target, or the like, and in general, it is preferable that the time is approximately 1 hour to 50 hours.

Furthermore, when the porous glass film is produced by using the production process of the present invention, for example, the phase separation glass film produced by the production process described above is prepared, and the phase separation glass film is subjected to the etching treatment, and thus the porous glass film is prepared. Here, a process for preparing the phase separation glass film is not limited to the process for producing the phase separation glass film by using the production process described above, and as the process, a process for acquiring a substrate on which the phase separation glass film produced by the production process described above is formed through assignment such as purchase is included.

Porous Glass Film

Hereinafter, the porous glass film 2 produced by the production process of the present invention will be described.

The phase separation includes spinodal phase separation and binodal phase separation. The pore (non-silica-rich phase of the phase separation glass film 1) of the porous glass film 2 obtained by the spinodal phase separation (non-silica-rich phase of the phase separation glass film 1) is a through hole which is connected from the surface to an inner portion. More specifically, a structure derived from the spinodal phase separation, that is, a spinodal structure is an “ant nest”-like structure in which holes are three-dimensionally interconnected with each other, wherein the skeleton of silicon oxide is a “nest” and the through hole is a “nest hole”. On the other hand, the porous glass film 2 obtained by the binodal phase separation has a structure in which independent holes which is a hole surrounded by a closed surface approximately in the shape of a sphere are discontinuously present in the skeleton of silicon oxide. The hole derived from the spinodal phase separation and the hole derived from the binodal phase separation are determined and distinguished according to a shape observation result of an electron microscope. In addition, the composition of the base glass powder 12 or the temperature condition at the time of performing the second heat treatment step is suitably controlled, and thus the type of phase separation is able to be controlled to be the spinodal phase separation or the binodal phase separation.

The thickness of the porous glass film 2 is not particularly limited, is preferably 200 nm to 50.0 μm, is more preferably 500 nm to 20.0 μm, and is even more preferably 1.5 μm to 10.0 μm. It is particularly preferable that the thickness is 2 μm to 10 μm. When the thickness of the porous glass film 2 is less than 200 nm, a porous glass film 2 having a high surface strength and a high void content (low refractive index) to have an effect of suppressing wavelength dependency of reflectance is not obtained. In contrast, when the thickness of the porous glass film 2 is greater than 50.0 μm, the influence of the haze increases, and thus it is difficult to use the porous glass film 2 as an optical member.

Specifically, the thickness of the porous glass film 2 is able to be determined, for example, by taking an SEM image (electron microscope picture) at an acceleration voltage of 5.0 kV using a scanning electron microscope (FE-SEMS-4800, manufactured by Hitachi, Ltd.). More specifically, the thickness of the porous glass film 2 disposed on the substrate 10 is measured at 30 or more points on the taken image, and the average value thereof is used.

The proportion of the void of the porous glass film 2, that is, the void content is not particularly limited, but is preferably 30 volume % to 70 volume %, and is more preferably 40 volume % to 60 volume %. When the void content is less than 30 volume %, the advantages of the porous film are not able to be sufficiently utilized, and when the void content is greater than 70 volume %, the surface strength tends to be decreased, and thus having a void content of less than 30 volume % or greater than 70 volume % is not preferable. In addition, it is desirable that the void content of the porous glass film 2 continuously increases from the substrate 10 towards the surface side of the porous glass film 2.

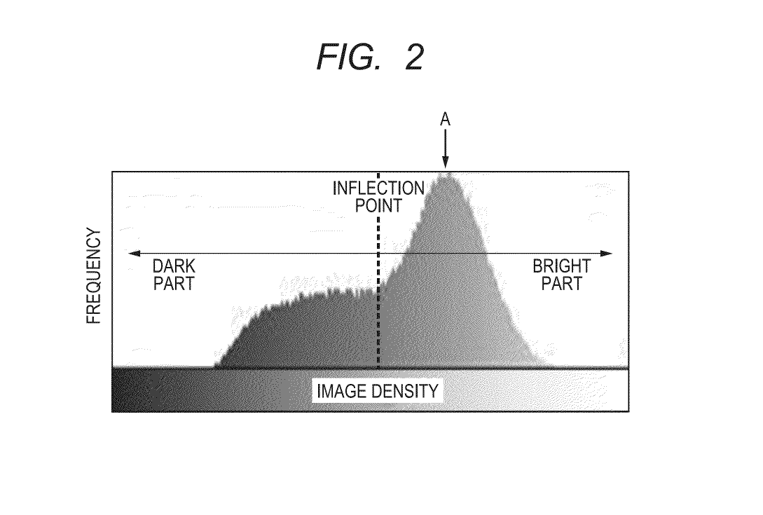

As a calculating method of the void content, for example, processing of binarizing the image of the electron microscope picture into a skeleton portion and a hole portion is performed. Specifically, the surface of the porous glass film 2 is observed at 100000-fold magnification (50000-fold magnification according to situations) at which the contrast density of a skeleton is easily observed at an acceleration voltage of 5.0 kV by using a scanning electron microscope (FE-SEMS-4800, manufactured by Hitachi, Ltd.). Then, the observed image is stored as a picture image, the SEM image is graphed with a frequency plotted for each image density by using image analysis software, and thus the void content is obtained. FIG. 2 is a diagram illustrating the frequency for each image density of a porous glass film 2 having a spinodal porous structure. A peak portion (location A) of the image density indicated by the downward arrow in FIG. 2 indicates the skeleton portion positioned on a front surface.

When the void content is determined by using FIG. 2, a bright portion (skeleton portion) and a dark portion (hole portion) are binarized into white and black by using an inflection point close to the peak position as a threshold value. Then, as for the proportion of the area of the black portion to the area of the entire portion (sum of the area of the white portion and the black portion), the average value in the entire image is obtained. Then, the obtained average value is taken as the void content.

The pore diameter of the porous glass film 2 is preferably 1 nm to 200 nm, and is more preferably 5 nm to 100 nm. When the pore diameter is less than 1 nm, the porous structure is not able to be sufficiently utilized, and when the pore diameter is greater than 100 nm, the surface strength tends to be lower, and thus having a pore diameter of less than 1 nm or greater than 100 nm is not preferable. However, it is preferable that the pore diameter is smaller than the thickness of the porous glass film 2.

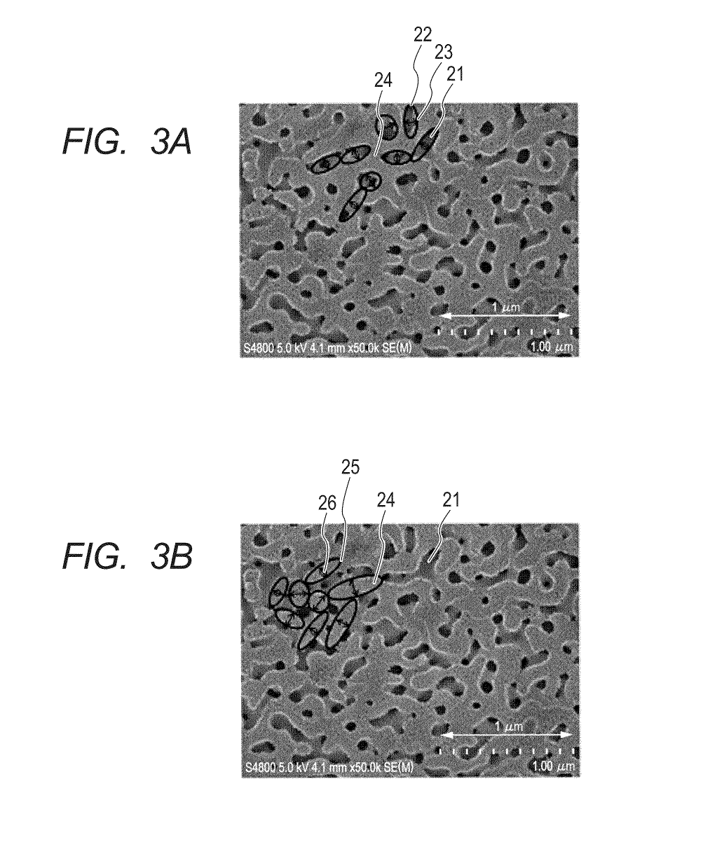

Furthermore, the pore diameter herein is defined by approximating a pore on the front surface side of the porous glass film 2 to a plurality of ellipses to obtain the average value of the minor axis of each of the approximated ellipses. FIGS. 3A and 3B are diagrams illustrating a specific example of a definition of the pore diameter of the pore of the porous glass film 2 and the skeleton diameter of the skeleton between the pores. For example, as illustrated in FIG. 3A, the pore diameter is obtained by approximating a pore 21 to a plurality of ellipses 22 using an electron microscope picture which is obtained by imaging the surface side of the porous glass film 2 to obtain the average value of a minor axis 23 of each of the ellipses. The pore 21 is measured for at least 30 points, and the average value thereof is obtained.

The skeleton diameter of the porous glass film 2 is preferably 1 nm to 50 nm, and is more preferably 5 nm to 50 nm. When the skeleton diameter is greater than 50 nm, scattering of light is remarkable, and thus transmittance considerably decreases. In addition, when the average skeleton diameter is less than 1 nm, the strength of the porous glass film 2 tends to be lower.

Furthermore, the skeleton diameter herein is defined by approximating a skeleton which is able to be observed at the time of imaging the surface side of the porous glass film 2 to a plurality of ellipses to obtain the average value of the minor axis of each of the approximated ellipses. For example, as illustrated in FIG. 3B, the skeleton diameter is obtained by approximating a skeleton 24 to a plurality of ellipses 25 using an electron microscope picture obtained at the time of imaging the surface side of the porous glass film 2 and by obtaining the average value of a minor axis 26 of each of the ellipses. The skeleton 24 is measured on at least 30 points, and the average value thereof is obtained.

The pore diameter or the skeleton diameter of the porous glass film 2 is able to be suitably controlled according to a material to be a raw material, a heat treatment condition at the time of performing spinodal phase separation (conditions at the time of performing the second heat treatment step), or the like.

The porous glass film 2 prepared by the process of the present invention is able to be used as an optical member or a member constituting an optical member. In addition, an optical member including the porous glass film 2, for example, is able to be mounted on an imaging device such as a digital camera or a digital camcorder.

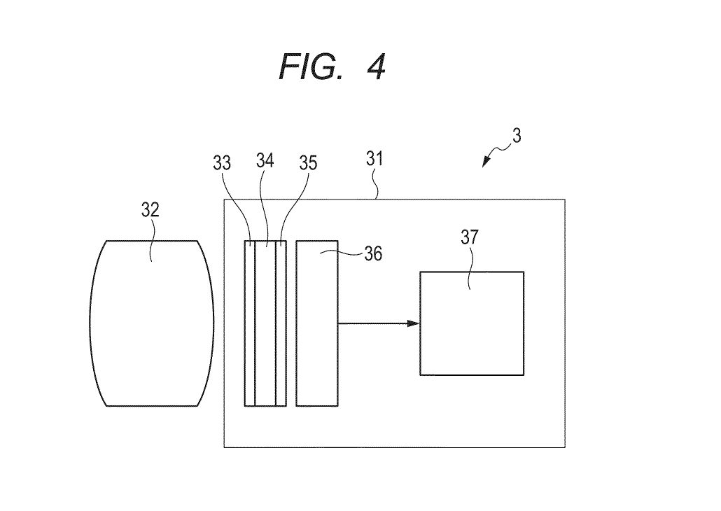

FIG. 4 is a schematic sectional view illustrating an example of an imaging device on which a glass member including a porous glass film which is obtained by the production process of the present invention is mounted as an optical member. Furthermore, an imaging device 3 of FIG. 4 is an imaging device for forming a subject image on an imaging element 36 from a camera, specifically, from a lens 32 through an optical filter 33. The imaging device 3 of FIG. 4 includes a main body 31, and a detachable lens 32. When the imaging device 3 of FIG. 4 is an imaging device such as a digital single lens reflex camera, an imaging lens (lens 32) used for imaging is replaced with a lens having a different focal distance, and thus picture images with various field angles are able to be obtained. The main body 31 included in the imaging device 3 of FIG. 4 includes an imaging element 36, an infrared cut filter 35, a lowpass filter 33, and an optical member 34. Here, the optical member 34 includes the porous glass film 2 prepared by the production process of the present invention. In addition, the optical member 34 includes the substrate 10, and thus is also able to be used as the lowpass filter 33.

The imaging element 36 included in the imaging device 3 of FIG. 4 is stored in a package (not illustrated), and the package maintains the imaging element 36 in a sealed state by using a cover glass (not illustrated). In addition, the imaging element 36 is connected to an image processing circuit 37, and information relating to the image received by the imaging element 36 is converted into data by the image processing circuit 37. Furthermore, as the imaging element 36, a CMOS element or a CCD element is able to be used.

In addition, a space between the optical filter such as the lowpass filter 33 or the infrared cut filter 35 and the cover glass (not illustrated) has a sealed structure due to a sealing member such as a double coated tape (not illustrated). Furthermore, in FIG. 4, an example where both of the lowpass filter 33 and the infrared cut filter 35 are provided as the optical filter is described, but any one of them may be omitted.

### EXAMPLE

Hereinafter, the present invention will be described in detail with reference to an example, but the present invention is not limited to the example described below.

### Example 1

### Preparation of Optical Member

According to the production process illustrated in FIGS. 1A to 1E, an optical member formed of the substrate 10, and the porous glass film 2 disposed on both faces of the substrate 10 was prepared.

(1) Used Material or the Like

(1-1) Substrate

As the substrate 10, a quartz glass substrate (manufactured by Iiyama Precision Glass Co., Ltd., with a softening point of 1700° C. and a Young's modulus of 72 GPa) was used. Furthermore, the used substrate 10 was obtained by cutting a plate-shaped member having a thickness of 0.5 mm into a size of 50 mm×50 mm, and by performing mirror polishing with respect to the member.

(1-2) Preparation of Glass Powder

A mixed powder of boric oxide, sodium oxide, and alumina was put into a platinum crucible such that the composition was as follows, and was melted at 1500° C. for 24 hours in the crucible.

B₂O₃: 79 weight %
Na₂O: 18 weight %
Al₂O₃: 3 weight %

Next, the melted glass was cooled to 1300° C., and then was poured into a graphite mold. After that, the glass poured into the mold was open-cooled for approximately 20 minutes in the air, and then was held in a slow cooling furnace at 500° C. for 5 hours. Next, the cooling was performed for 24 hours, and thus borate glass in the shape of a block was obtained. Next, the borate glass was pulverized until the average particle diameter became 4.5 μm by using a jet mill, and thus glass powder was obtained. The glass transition temperature of the composition was approximately 480° C.

(1-3) Preparation of Glass Paste

The primary materials described above were stirred and mixed, and thus a glass paste was obtained.

Glass Powder: 60.0 parts by mass
α-Terpineol: 44.0 parts by mass
Ethyl Cellulose (registered trademark; ETHOCEL Std 200 (manufactured by The Dow Chemical Company)): 2.0 parts by mass

(2) Film Formation Step (FIG. 1A)

The glass paste including the glass powder 12 and the binder 13 was applied onto one face (front surface 10a) of the substrate 10 by screen printing, and thus the film 11a was formed. MT-320TV manufactured by Microtek Inc. was used as a printer at the time of performing the present step, and a solid image of 40 mm×40 mm of #500 was used as a plate used in the printing. Subsequently, the substrate 10 on which the film 11a was formed was allowed to stand in a dry furnace at 100° C. for 10 minutes, and a solvent was evaporated. Next, the film 11b was formed by applying the glass paste onto the other face (back surface 10b) of the substrate 10 using the same process (screen printing method), and then was allowed to stand in the dry furnace at 100° C. for 10 minutes, and thus the solvent included in the film 11b was evaporated. As described above, a sample was prepared in which the respective films (11a and 11b) were formed on both faces (10a and 10b) of the substrate 10 (FIG. 1A).

(3) Baking Step (FIGS. 1B to 1D)

Subsequently, the substrate 10 on which the film (11a and 11b) was formed was placed on the support member 22 disposed on the thermal conductive member 21 formed of Si. At this time, as illustrated in FIG. 1B, the position of the substrate 10 was adjusted such that the substrate 10 was supported in a state where the support member 22 was not in contact with the films (11a and 11b). Furthermore, the height of each of a plurality of support members 22 in FIG. 1B was uniformly adjusted, and thus the substrate 10 was horizontally placed with respect to the thermal conductive member 21 in a state where a gap between the film 11b and the thermal conductive member 21 was approximately 5 mm. Next, the thermal conductive member 21 along with the substrate 10 was set in a muffle furnace. Next, the rate of temperature increase was set to 10° C./min, and the temperature in the furnace was increased up to 900° C., and then a heat treatment was performed at this temperature (900° C.) for 1 hour, and thus the base glass film 14 was obtained (FIG. 1C). Subsequently, the temperature in the furnace was cooled to room temperature, and then a phase separation heat treatment was performed at 550° C. for 50 hours. Then, both surfaces of the film disposed on both faces of the substrate 10 was polished, and thus the phase separation glass film 1 was formed on both faces of the substrate 10 (FIG. 1D).

(4) Etching Step (FIG. 1E)

Next, the substrate 10 on which the phase separation glass film 1 was formed was dipped in 1.0 mol/L of an aqueous nitric acid solution which was heated to 80° C., and was allowed to stand at this temperature (80° C.) for 24 hours. Subsequently, the substrate 10 was dipped in distilled water which had been heated to 80° C., and was allowed to stand for 24 hours. Next, the substrate 10 was taken out from the distilled water, and was dried at room temperature for 12 hours, and thus a sample of an optical member including the porous glass film 2 on both faces of the substrate 10 was obtained (FIG. 1E).

(5) Evaluation of Optical Member

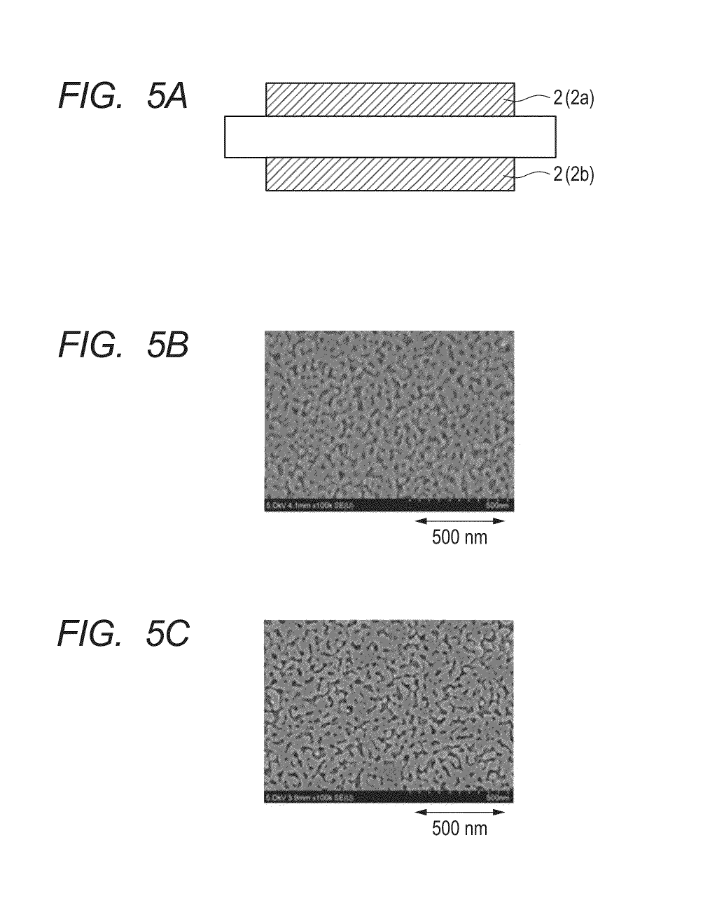

For the obtained sample (optical member), an SEM image (electron microscope picture) was taken at an acceleration voltage of 5.0 kV by using a scanning electron microscope (FE-SEMS-4800, manufactured by Hitachi, Ltd.). From the taken SEM image, it was confirmed that the porous glass film 2 having a film thickness of 4.0 μm was formed on both faces of the substrate 10. FIG. 5A is a sectional view of the sample prepared in the present example, FIG. 5B is an SEM image of the porous glass film 2a on the side of the front surface 10a of the substrate, and FIG. 5C is an SEM image of the porous glass film 2b on the side of the back surface 10b of the substrate. From FIGS. 5B and 5C, it was found that the porous glass films (2a and 2b) were formed on both faces (10a and 10b) of the substrate 10 in which the porous glass films (2a and 2b) and the substrate 10 were formed of the same material.

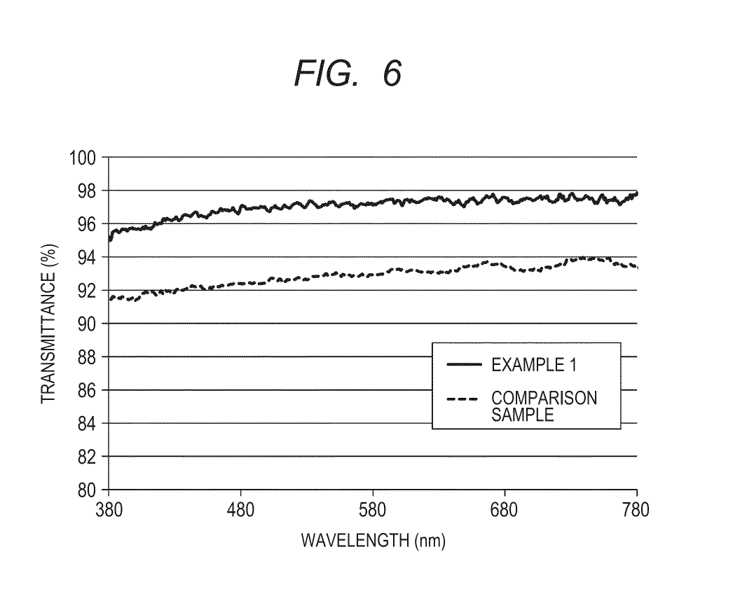

Next, the transmittance of the obtained sample was measured. As a measurement device, a spectrophotometer (manufactured by Jasco Corporation, an ultraviolet-visible spectrophotometer V-570 and an automatic absolute reflection ratio measurement device ARM-500N) was used. FIG. 6 is a diagram illustrating the transmittance (solid line) of the optical member prepared in the present example. Furthermore, in FIG. 6, a measurement result (broken line) of a comparative sample in which the porous glass film 2 was formed on only one face of the substrate 10 as a comparative target is also illustrated. From FIG. 6, it was found that the fluctuation of the transmittance of the optical member prepared in the present example depending on wavelength is decreased, and the transmittance of the optical member is higher than that of the comparative sample in which the porous glass film 2 is formed on only one face of the substrate 10.

As described with reference to the embodiment and the example, according to the present invention, it is possible to provide a process for producing a phase separation glass film for simultaneously forming a porous glass film on both faces of a substrate in which the porous glass film and the substrate are formed of the same material.

While the present invention has been described with reference to an exemplary embodiment, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2014-153916, filed Jul. 29, 2014, and Japanese Patent Application No. 2015-097399, filed May 12, 2015 which are hereby incorporated by reference herein in their entirety.

What is claimed is:

1. A process for producing a phase separation glass film, comprising:
a film formation step of forming a film including glass powder on both faces of a substrate; and
a baking step of baking the film to form a phase separation glass film on both faces of the substrate simultaneously,
wherein the baking step is performed in a state in which the substrate is disposed such that an in-plane direction of the substrate is perpendicular to a gravitational direction by supporting the substrate at a portion where the film is not formed, and
wherein in the baking step a member having a thermal conductivity higher than that of the substrate is disposed below the substrate so as not to be in contact with the film.

2. The process for producing a phase separation glass film according to claim 1,
wherein an average particle diameter of the glass powder is less than or equal to 10 μm.

3. The process for producing a phase separation glass film according to claim 1,
wherein the member having the thermal conductivity higher than that of the substrate is Al₂O₃, Si, or SiC.

4. A process for producing a porous glass film, comprising:
a step of preparing a phase separation glass film which is produced by the process for producing a phase separation glass film according to claim 1; and
an etching step of simultaneously forming the porous glass film on both faces of the substrate by performing an etching treatment with respect to the phase separation glass film.

5. A glass member, comprising:
a substrate; and
a porous glass film which is disposed on both faces of the substrate,
wherein the porous glass film has a spinodal structure.

6. The glass member according to claim 5,
wherein a thickness of the porous glass film is 2 μm to 10 μm.

7. The glass member according to claim 5,
wherein a skeleton diameter of a skeleton forming the spinodal structure is 5 nm to 50 nm.

8. An imaging device, comprising:
a glass member; and
an imaging element,
the glass member comprising:
a substrate; and
a porous glass film which is disposed on both faces of the substrate,
wherein the porous glass film has a spinodal structure.
